(19) United States
(12) Patent Application Publication
(10) Pub. No.: US 2010/0039260 A1
(43) Pub. Date: Feb. 18, 2010

(54) SECURITY DEVICE AND METHODOLOGY

(76) Inventor: Sanford BOSIN, Monroe Township, NJ (US)

Correspondence Address: MERCHANT & GOULD PC, P.O. BOX 2903, MINNEAPOLIS, MN, 55402-0903, US

(21) Appl. No.: 12/562,566

(22) Filed: Sep. 18, 2009

Related U.S. Application Data
(63) Continuation of application No. 11/087,633, filed on Mar. 24, 2005, now Pat. No. 7,594,416.

(51) Int. Cl. E05B 45/06; E05B 17/00; E05B 37/00; E05B 35/00; E05B 67/00; G08B 29/00

(52) U.S. Cl. 340/542; 70/441; 70/286; 70/336; 70/22; 70/31; 340/5.52

(57) ABSTRACT

A lock having a body, a face, a shackle and an audio and/or a visual system. The audio system includes a speaker system and a controller, and the visual system includes an indicator light and a controller. The systems also employ a battery and a battery indicator light, e.g., an LED, indicating when the battery needs to be replaced. The audio system emits an audible sequence and the visual system emits a light sequence when the lock is unlocked, reminding a user to lock the lock.

### CROSS-REFERENCE TO RELATED APPLICATIONS

This Application is a Continuation of U.S. patent application Ser. No. 11/087,633, filed Mar. 24, 2005, now U.S. Pat. No. 7,594,416. The disclosure of this application is incorporated herein by reference.

### FIELD OF THE INVENTION

The present invention relates to locks and more particularly to a combination lock that includes an indicator when the lock is left open or unlocked.

### BACKGROUND OF THE INVENTION

Locks, for example, combination locks are well known, and are widely used in various occasions to provide safety protection for goods and properties. At present there are many different types of portable locks available on the market, chiefly combination locks. One major drawback of prior and existing locks, however, is that a user may forget to lock the lock. This inherent problem in the usage of locks has not been adequately addressed by the prior art. Thus, it is desirable to provide a lock that includes an indicator that informs the user when the lock is left open or unlocked.

### SUMMARY OF THE INVENTION

The present invention is a lock having a body, a face, a shackle, and an audio or visual system. The audio system includes a speaker system and a controller, and the visual system includes an indicator light and a controller. The systems also employ a battery and a battery indicator light, e.g., an LED, indicating when the battery needs to be replaced. The audio system emits an audible sequence and the visual system emits a light sequence when the lock is unlocked, reminding a user to lock the lock.

### BRIEF DESCRIPTION OF THE DRAWINGS

The foregoing and other features and advantages of the present invention will be more clearly understood from the following detailed description and the accompanying drawings, in which,

FIG. 1 is an internal view of the combination lock of the present invention; and

FIG. 2 is a front view of the combination lock of the present invention.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

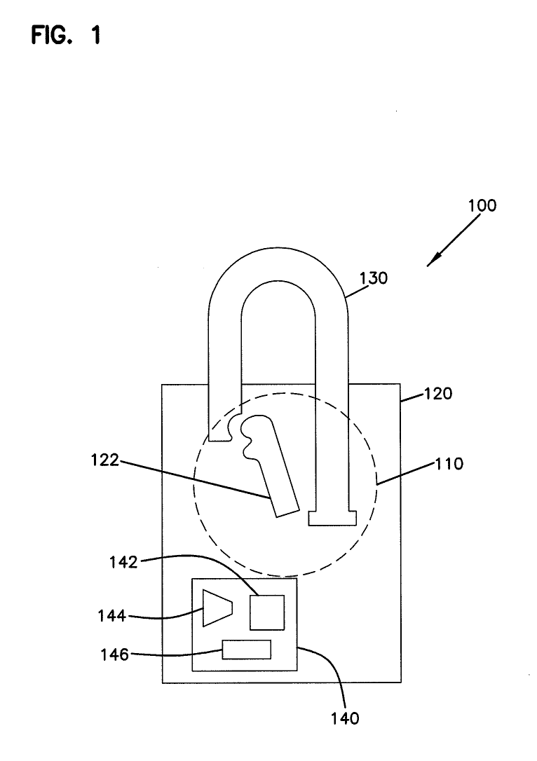

A combination lock is shown in FIG. 1, and generally designated with the reference numeral 100. The combination lock 100 is of a typical combination lock design, as is known in the art. For example, the combination lock 100 has a wheel face 110, a body 120, and a shackle 130, as is known in the art. The body 120 includes cams 122 that engage the shackle 130, allowing the combination lock 100 to lock and unlock, as is understood in the art. Additionally, the combination lock 100 has an audio system 140. The audio system 140 includes a battery 142, e.g., a nickel-cadmium battery, that powers a speaker system 144. The speaker system 144 is controlled by a controller 146. The controller 146 communicates with the shackle 130.

During the operation of the present invention, when the shackle 130 is in an open position, i.e., when the combination lock 100 is unlocked, the controller 146 directs the speaker system 144 to emit an audible sequence. An exemplary audible sequence would be three beeps or chirps in rapid succession repeated every thirty seconds. When the shackle 130 is in the closed position, i.e., when the combination lock 100 is locked, as illustrated in FIG. 1, the controller 146 would direct the speaker system 144 to remain silent. In this fashion, users of such locks, whether in gyms, storage areas or in any other usage, would readily know the status of their lock and better assure the protection of their possessions

It should be understood that the audio system 140 can emit a sound, e.g., a tone, to alert the user of the opened status of the lock or employ a number of sounds and/or tones, e.g., repeating a sound or tone periodically, varying the sound or tone by frequency, volume or other discernable means, increasing the sound or tone in intensity as long as the locking mechanism is unlocked, and other patterns, e.g., the aforementioned three beeps.

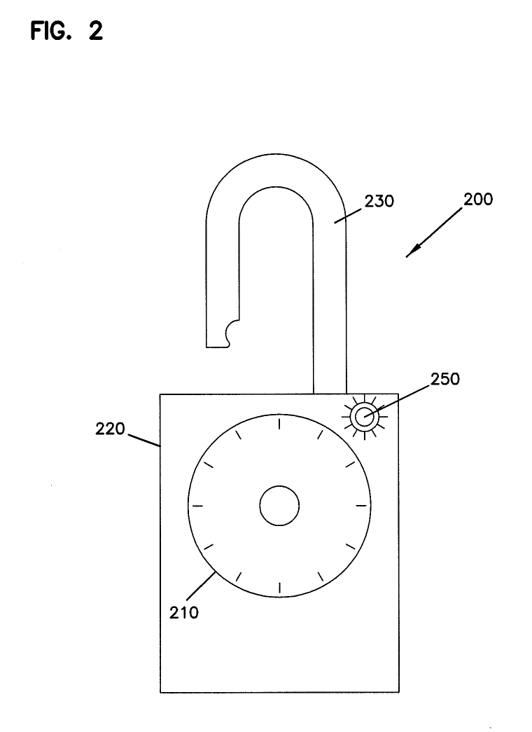

With respect now to FIG. 2, there is shown therein another embodiment of the present invention, generally designated by the reference numeral 200. As discussed above in connection with FIG. 1, the combination lock 200 may be a typical combination lock with the aforementioned constituent parts, including a wheel face 210, a body 220 and a shackle 230, as is known in the art, or any other locking mechanisms, e.g., a key lock or other conventional or high-tech security devices, e.g., a biometric mechanism with a lock component. Additionally, the combination lock 200 in this embodiment has an indicator light 250. It should be understood that indicator light 250 may be an LED or another light that indicates a low battery charge.

The combination locks 100 and 200 with the indicators maybe used in numerous applications, e.g., to lock a tool shed, a tool box, a school locker, a gym locker, etc. The indicator sound or light indicates when the lock 100/200 is open or unlocked, thus reminding a user to lock the combination lock. Additionally, the battery indicator light 250 indicates when the battery 142 requires replacement.

It should be understood that the indicator light 250 or any other visual or light system employed in the instant invention can emit a constant or flashing beam of light to alert the user of the opened status of the lock. The light source, when activated, can emit a continuous light of a given intensity, vary the intensity, e.g., increase intensity as long as the locking mechanism is unlocked, employ a number of light sources, each emitting respective visual signals which may differ in color in intensity, and other patterns.

It should be understood that the principles of the present invention can be employed in combination, e.g., the locking mechanism can have both an audio system and a visual system to alert and user of the opened status of the lock. The light source in such an embodiment could serve as a constant reminder of the lock status and the audio source chiming in at periodic intervals to further alert the user. Usage of two alert mechanisms is preferred since forgetful individuals may require additional reminders. Additional alert mechanisms include a vibratory device to start vibrating upon unlocking the lock or at a time interval afterwards. Since the vibrating sensation must normally be perceived by touch or close physical contact between the user and the lock, vibrations alone would not normally be enough. However, vibrations could generate sounds that would alert the user, thereby serving the overall function.

The foregoing description of the present invention provides illustration and description, but is not intended to be exhaustive or to limit the invention to the precise one disclosed. Modifications and variations are possible consistent with the above teachings or may be acquired from practice of the invention. Thus, it is noted that the scope of the invention is defined by the claims and their equivalents.

We claim:

1. A locking device comprising:
a lock mechanism, said lock mechanism having a locked state and an unlocked state; and
an indicator, said indicator being activated when said lock mechanism is in said unlocked state, and said indicator being deactivated when said lock mechanism is in said locked state,
wherein a user of said locking device is alerted by a first signal when said lock mechanism is in said unlocked state, and
wherein the continued unlocked state of said lock mechanism for a time interval after the first signal causes generation of a second signal.

2. The locking device according to claim 1, wherein said indicator comprises an audio system,
wherein said first signal is an audible signal emitted when said lock mechanism enters said unlocked state, and
wherein said audible signal is deactivated when said lock mechanism enters said locked state.

3. The locking device according to claim 2, wherein said audio system comprises:
a speaker; and
a controller,
wherein said speaker emits said audible signal when said lock mechanism enters said unlocked state, and
wherein, upon entry by said lock mechanism into said locked state, said controller instructs said speaker to cease said audible signal.

4. The locking device according to claim 3, wherein, after said time interval after said first signal, said controller instructs said speaker to emit another audible signal.

5. The locking device according to claim 2, wherein said audible signal is a tone.

6. The locking device according to claim 5, wherein said audible signal comprises a plurality of tones, a user of said locking device being capable of distinguishing among the differing tones, and
wherein said first and second signals comprise respective tones.

7. The locking device according to claim 2, wherein said audible signal is repeated periodically.

8. The locking device according to claim 2, wherein the volume of said audible signal varies.

9. The locking device according to claim 8, wherein the volume of said audible signal increases as long as said lock mechanism remains in said unlocked state.

10. The locking device according to claim 8, wherein the volume of said audible signal changes after said time interval.

11. The locking device according to claim 1, wherein said indicator is a light system,
wherein said first signal is a visual signal emitted when said lock mechanism enters said unlocked state, and
wherein said visual signal is deactivated when said lock mechanism enters said locked state.

12. The locking device according to claim 11, wherein said light system comprises:
an indicator light; and
a controller,
wherein said indicator light emits said visual signal when said lock mechanism enters said unlocked state, and
wherein, upon entry by said lock mechanism into said locked state, said controller instructs said indicator light to cease said visual signal.

13. The locking device according to claim 11, wherein said visual light is a continuous light.

14. The locking device according to claim 11, wherein said visual signal comprises a plurality of light signals.

15. The locking device according to claim 11, wherein said visual signal comprises a flashing signal, said flashing signal repeated periodically.

16. The locking device according to claim 11, wherein the intensity of said visual signal varies.

17. The locking device according to claim 16, wherein the intensity of said visual signal increases as long as said lock mechanism remains in said unlocked state.

18. The locking device according to claim 16, wherein the intensity of said visual signal changes after said time interval.

19. The locking device according to claim 11, wherein said light system comprises a plurality of indicator lights.

20. The locking device according to claim 19, wherein said plurality of indicator lights emit respective visual signals, a user of said locking device being capable of distinguishing among the differing visual signals, and
wherein said first and second signals comprise respective visual signals.

21. The locking device according to claim 19, wherein respective visual signals differ in color or intensity.

22. The locking device according to claim 11, wherein said visual signal comprises a light varying in color or intensity.

23. The locking device according to claim 11, wherein said indicator comprises an LED.

24. The locking device according to claim 1, wherein said indicator comprises a vibratory system,
wherein said lock mechanism vibrates when entering said unlocked state, and ceases vibrating when entering said locked state.

25. The locking device according to claim 24, wherein after said time interval after said first signal, said lock mechanism vibrates differently.

26. The locking device according to claim 1, wherein said indicator is selected from the group consisting of: an audio system, a visual system, a vibratory system and combinations thereof.

27. The locking device according to claim 1, wherein said locking device is selected from the group consisting of: a combination lock, a key lock, a biometric mechanism, a padlock and combinations thereof.

28. A method for securing an object comprising:
locking said object using a lock,
said lock including an indicator, said lock having a locked state and an unlocked state;
alerting a user of said lock, by a first signal from said indicator, when said lock enters said unlocked state,
further alerting said user of said lock, by a second signal from said indicator, when said lock remains in said unlocked state after a time interval after said first signal.

29. An alert signal device comprising:
first means for generating a first signal upon unlocking a lock means; and
second means for generating, after a time interval after generation of said first signal, an alert signal discernable to a user and alerting said user to the unlocked state of said lock means.
